(19) United States
(12) Patent Application Publication
(10) Pub. No.: US 2010/0015303 A1
(43) Pub. Date: Jan. 21, 2010

(54) FOOD PREPARATION DEVICE AND METHOD

(75) Inventor: Brian Chuan Chai Law, San Francisco, CA (US)

Correspondence Address: PEARNE & GORDON LLP, 1801 EAST 9TH STREET, SUITE 1200, CLEVELAND, OH, 44114-3108, US

(73) Assignee: Aktiebolaget Electrolux, Stockholm (SE)

(21) Appl. No.: 12/441,961

(22) PCT Filed: Sep. 24, 2007
(86) PCT No.: PCT/EP2007/008274

§ 371 Date: Jul. 8, 2009

(30) Foreign Application Priority Data
Sep. 25, 2006 (SE) 0601989-7

(51) Int. Cl. A47J 27/00; A23L 1/01

(52) U.S. Cl. 426/243; 99/451

(57) ABSTRACT

The present invention is concerned with the field of food preparation. More specifically, the present invention is related to a food preparation device and a method of preparing a foodstuff. It is a purpose of the present invention to overcome some of the drawbacks associated with known cooking methods. The food preparation device comprising a container (2,3) having one or more holes that are suitable for outlet of air and creating a vacuum, and a lid (1) comprising a far infrared radiation source, wherein said lid (1) is sealable to said container (2,3).

### TECHNICAL FIELD

The present invention is concerned with the field of food preparation. More specifically, the present invention is related to a food preparation device and a method of preparing a foodstuff.

### BACKGROUND OF THE INVENTION

More than ever, consumers are demanding for quality and health. The food industry rushes to provide new and interesting foods to meet the changing needs and desires of consumers. Food labels promise less fat, fewer calories, and more flavour for people who spend an average of 30 min preparing dinner. While constantly demanding novel foodstuff with new properties, such as added vitamins, liquid food, food gels etc, we are also demanding faster ways to prepare and consume the foodstuff, but remain healthy.

Frying, a commonly used cooking method that requires oil and fats, which are known to be unhealthy, uses a convection method of heat transfer to cook food. It is highly desirable to eliminate oil and fats as a cooking medium.

### SUMMARY OF THE INVENTION

It is a purpose of the present invention to overcome some of the drawbacks associated with known cooking methods.

For these and other purposes that will be evident from the specification, the present invention provides a food preparation device and a method of preparing a foodstuff.

### BRIEF DESCRIPTION OF THE DRAWINGS

FIG. 1 shows a food preparation device according to the invention.

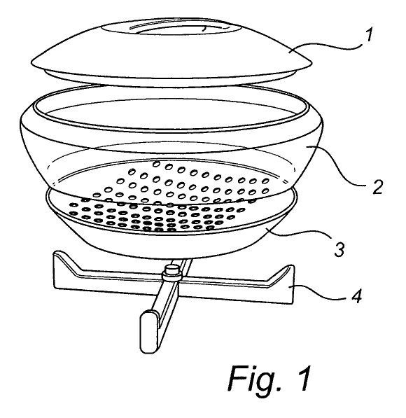

### DETAILED DESCRIPTION OF THE INVENTION

Infrared cooking uses high-efficiency radiant energy. High-frequency electromagnetic waves from the invisible end of the light spectrum travel from the infrared source to the food cooked without heating the air. Far infrared radiation works well under vacuum, as it does not require any medium for the heat transfer.

According to a first aspect, the present invention provides a food preparation device comprising a container (2,3) and a lid (1). The lid is sealable to said container (2,3), i.e. the space within the container (2,3) can be closed, preventing transport of air and maintaining a vacuum created within the container (2,3).

The container (2,3) has one or more holes, air outlets, which are useful for creating a vacuum within said container (2,3) when connected to a means for air suction. Under vacuum, no juices or vapours escape from the container (2,3), so that food cooked “sous vide” is full of flavour. “Sous vide”, which is French for “under vacuum” is a concept adopted from the finest European recipe for healthy and tasty food.

In a preferred food preparation device according to the invention, the container (2,3) consists of two separate parts, a bottom part (3) harbouring said one or more holes (air outlets) and a transparent sidewall part (2), essentially constituting the container wall. The bottom part (3) is sealable to said sidewall part (2) in order to maintain a vacuum created in the container (2,3). The bottom part (2) can be docked in a suitable docking device (4).

Optionally, the container (bottom part (3) or sidewall part (2)) can be equipped with a glowing light-emitting diode (LED), which mimics fire flames during operation.

The container wall (2) is made of a transparent material which is suitable for use with vacuum pressure, which advantageously makes it possible to observe foodstuff while it is being cooked. This is advantageous for educational purposes, but it is also highly suitable for the inexperienced home user, as this allows for facilitated care and early identification of problems.

Preferred container wall materials include glass and transparent plastics. The thickness of the container walls is typically in the range of 1-20 mm, such as 1-5 mm, but can be varied depending on requirements.

The lid (1) is equipped with a downward directed far infrared (IR) radiation source, which emits far IR radiation (wavelength 15-1000 μm) onto the foodstuff enclosed in the container (2,3). Far IR radiation heats the food without heating the surrounding air. Therefore, the food cooks more quickly, resulting in a greater retention of food weight. Less heating of the surrounding air results in a cooler kitchen.

The food preparation device is suitable for home use on a kitchen countertop or at a table. The outer dimensions of the container are preferably less than 500×500×500 mm, i.e. it will fit into a box with these inner dimensions. The container may have any suitable form, including cube, parallelepiped, cylinder, sphere, etc.

This food preparation device is useful in the kitchen as well as in the dining room. It is a product for people who care about food presentation, not only a dinner to be eaten but also to be enjoyed. It is useful for educational purposes, since the transparency allows observation of the cooking process.

According to another aspect, the present invention provides a method of preparing a foodstuff, comprising the following steps:
i) arranging an unprepared foodstuff in a sealed container,
ii) creating a vacuum in said container,
iii) exposing said foodstuff to far IR radiation.

The method is preferably carried out employing the food preparation device according to the invention.

1. A food preparation device comprising a container (2,3) having one or more holes that are suitable for outlet of air and creating a vacuum, and a lid (1) comprising a far infrared radiation source, wherein said lid (1) is sealable to said container (2,3).

2. A food preparation device according to claim 1, wherein said container (2,3) consists of a bottom part (3) harbouring said one or more holes, and a transparent sidewall part (2), wherein said bottom part (3) is sealable to said sidewall part (2).

3. A method of preparing foodstuff, comprising the following steps:
i) arranging unprepared foodstuff in a sealed container,
ii) creating a vacuum in said container,
iii) exposing said foodstuff to far infrared radiation.
